(19) United States
(12) Patent Application Publication
(10) Pub. No.: US 2022/0120995 A1
(43) Pub. Date: Apr. 21, 2022

(54) EXTERNAL LENS STRUCTURE AND LEN STRUCTURE MOUNT

(71) Applicant: GUANGDONG SIRUI OPTICAL CO., LTD., ZHONGSHAN (CN)

(72) Inventors: JIE LI, ZHONGSHAN (CN); CHAOMIN GAN, ZHONGSHAN (CN)

(73) Assignee: GUANGDONG SIRUI OPTICAL CO., LTD., ZHONGSHAN (CN)

(21) Appl. No.: 16/493,297

(22) PCT Filed: Jul. 16, 2019
(86) PCT No.: PCT/CN2019/096165

§ 371 Date: Sep. 11, 2019

(30) Foreign Application Priority Data
Jul. 1, 2019 (CN) 201910587135.5

(51) Int. Cl. G02B 7/02; G02B 7/14

(52) U.S. Cl. CPC G02B 7/021; G02B 7/14; G02B 7/028

(57) ABSTRACT

An external lens structure includes a lens assembly and a lens mount. The lens assembly includes a mirror chamber and a support seat disposed at a bottom of the mirror chamber. The lens assembly and the lens mount are two separate components, and the support base is rotatably connected with the lens mount, where the support seat is rotated relative to the lens mount. The lens assembly and the lens mount may be fixedly connected with the mounting body, and the lens assembly may be relatively rotated relative to the mounting body to ensure that the direction of the lens assembly may be rotated to the correct direction at all times to adapt to different models of mobile phones.

### TECHNICAL FIELD

The invention relates to the technical field of smart device photography accessories, in particular to a lens structure and an additional lens mechanism.

### BACKGROUND

Today's society is in a rapidly developing information age, and mobile phones as communication consumer goods have become a necessity for people's lives today. With the development in optoelectronics and precision technologies, mobile phones integrate a variety of functions based on the original communication functions, such as digital camera functions. In recent years, with the increasing size of the photosensitive elements of mobile phone cameras and the addition of phase focusing and optical image stabilization, mobile phones have gradually replaced traditional digital cameras as the first choice for daily photography and photography, and various mobile phone lenses have also developed.

In the prior art, the film or camera lens is generally connected to the mobile phone case or the mobile phone accessory by means of a connection bayonet or bolt fixing, and the bolt is directly fixed by means of bolting. The method of connecting the buckle to realize the buckle needs to be rotated 90 degrees. The degree of locking is different, and the rotation tightening directions required by different types of mobile phones are inconsistent, so the angle of the lens should be different by 90 degrees, which affects the use of the film or camera lens.

### SUMMARY

It is an embodiment of the present invention to provide a lens structure and an additional lens mechanism to solve the technical problem that the film lens of the prior art needs to maintain a correct use angle.

In another embodiment, the technical solution adopted by embodiments of the present invention is to provide a lens structure including a lens assembly and a lens mount, the lens assembly including a mirror chamber and a support seat disposed at the bottom of the mirror chamber, the lens mount and support seat is rotatably coupled to the support.

Further, the lens mount is sleeved on the outer side of the support seat, or the support seat is sleeved on the outer side of the lens mount.

Further, the support base is a hollow cylindrical ring seat, and the receiving cavity is a hollow circular receiving cavity and sleeved outside the support seat.

Further, the support base and the receiving cavity are detachably connected by an elastic expansion and contraction assembly.

Further, the elastic telescopic assembly includes a first elastic member and at least one fixing leg protruding from the support base, and two ends of the first elastic member may be configured to abut against the support base and the fixing foot, respectively. The inner side wall of the accommodating cavity is provided with a guiding groove for rotating the fixing leg, and the fixing leg may be embedded in the guiding groove.

Further, the outer side wall of the support seat is provided with a groove, and the first elastic member and the fixing leg are disposed in the groove, and one end of the first elastic member and the groove are configured to abut the inner wall and the other end is configured to abut against the fixed leg.

Further, a rotation limiting assembly for defining rotation of the lens assembly and the lens mount is further included.

Further, the rotation limiting assembly includes a second elastic member and a first stopper pin connected to the second elastic member, and the support seat is formed with a cavity for accommodating the second elastic member. One end of the one pin is fixedly connected to the second elastic member, and the other end may be configured to abut against the lens mount.

Further, the lens mount is provided with at least one limiting hole toward a side of the lens assembly, and the first locking pin may be inserted into the limiting hole.

Further, the number of the limiting holes is at least two, and the angle between the two limiting holes on the lens clip is 90 degrees.

Further, the rotation limiting assembly further includes a dial key for driving the first blocking pin to move up and down.

The present invention also discloses an additional lens mechanism comprising the lens structure of any of the above and a mounting body for mating with the smart device, the lens structure being mounted to the smart device by the mounting body.

Further, the lens mount is detachably mounted on the mounting body.

Further, the bottom of the lens mount is provided with a second stop pin defining an angle of the lens structure and the mounting body.

Further, the second stop pin is connected to the lens mount through a third elastic member, and the second stop pin may be configured to abut against the side wall of the mounting body.

Further, a filter is further included, the filter being detachably fixed to a side of the mirror chamber away from the lens mount.

Further, a soft strip is disposed between the filter and the mirror chamber.

The lens structure and the additional lens mechanism according to embodiments of the present invention have the beneficial effects that the lens structure and the additional lens mechanism of the present invention divide the lens assembly and the lens mount into two separate components, the support seat and the prior art, compared with the prior art. The lens mount is rotatably connected, that is, the support base may be rotated relative to the lens mount, that is, the lens assembly and the lens mount may be rotated relative to each other, and the lens mount may be fixedly coupled to the mounting body, and the lens assembly may be relatively rotated relative to the mounting body. In order to ensure that the direction of the lens assembly may always be rotated to the correct direction, to adapt to different models of mobile phones.

### BRIEF DESCRIPTION OF THE DRAWINGS

In order to more clearly illustrate the specific embodiments of the present invention or the technical solutions in the prior art, the drawings to be used in the specific embodiments or the description of the prior art may be briefly described below, and obviously, the drawings in the following description, are some embodiments of the present invention, and those skilled in the art may obtain other drawings based on these drawings without any creative work.

FIG. 1 is a schematic perspective structural view of a lens structure according to an embodiment of the present invention.

FIG. 2 is a schematic diagram of an exploded structure of a lens structure according to an embodiment of the present invention.

FIG. 3 is a schematic top plan view of a lens structure according to an embodiment of the present invention.

FIG. 4 is a cross-sectional structural view taken along line A-A of FIG. 3.

FIG. 5 is a schematic perspective structural diagram of an additional lens mechanism according to an embodiment of the present invention, wherein a smart device is not shown.

FIG. 6 is an exploded structural view of an additional lens mechanism according to an embodiment of the present invention, wherein a smart device is not shown.

FIG. 7 is a schematic perspective structural view of an additional lens mechanism according to an embodiment of the present invention.

FIG. 8 is a schematic rear view showing the structure of an additional lens mechanism according to an embodiment of the present invention.

FIG. 9 is a cross-sectional structural view taken along line B-B of FIG. 8.

### DESCRIPTION OF THE REFERENCE NUMBERS

1, lens assembly; 2, lens mount; 3, rotation limiting assembly; 4, installation body; 5, smart equipment; 6, filter; 11, mirror room; 12, support seat; 13, elastic telescopic assembly; a groove; 122, a cavity; 131, a first elastic member; 132, a fixed foot; 21, a receiving cavity; 22, a first stop pin; 23, a third elastic member; 24, a snap protrusion; guide groove; 212, limiting hole; 31, second elastic member; 32, first blocking pin; 33, dial button; 41, annular card slot; 411, notch; 61, rubber strip.

### DETAILED DESCRIPTION

The technical solutions of the present invention may be clearly and completely described in the following with reference to the accompanying drawings. It is obvious that the described embodiments are a part of the embodiments of the present invention, and not all of the embodiments. All other embodiments obtained by those skilled in the art based on the embodiments of the present invention without creative efforts are within the scope of the present invention.

In the description of the present invention, it is to be noted that the terms “center”, “upper”, “lower”, “left”, “right”, “vertical”, “horizontal”, “inside”, “outside”, etc. The orientation or positional relationship of the indications is based on the orientation or positional relationship shown in the drawings, and is merely for the convenience of the description of the invention and the simplified description, rather than indicating or implying that the device or component referred to has a specific orientation, in a specific orientation. The construction and operation are therefore not to be construed as limiting the invention. Moreover, the terms “first,” “second,” and “third” are used for descriptive purposes only and are not to be construed as indicating or implying relative importance.

In the description of the present invention, it should be noted that the terms “installation”, “connected”, and “connected” are to be understood broadly, and may be fixed or detachable, for example, unless otherwise explicitly defined and defined, connected, or integrally connected; may be mechanical or electrical; may be directly connected, or indirectly connected through an intermediate medium, may be the internal communication of the two components. The specific meaning of the above terms in the present invention may be understood in a specific case by those skilled in the art.

Further, the technical features involved in the different embodiments of the present invention described below may be combined with each other as long as they do not constitute a conflict with each other.

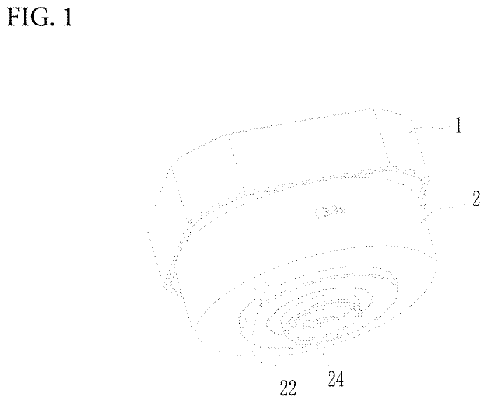

Referring to FIG. 1 to FIG. 4 together, the lens structure according to embodiments of the present invention may now be described. The lens structure includes a lens assembly 1 and a lens mount 2, the lens assembly 1 includes a mirror chamber 11 and a support base 12 disposed at a bottom of the mirror chamber 11, the lens mount 2 and the support base 12 are rotatably connected.

According to the lens structure according to embodiments of the present invention, the lens assembly 1 and the lens mount 2 are divided into two separate components, and the support base 12 may be rotatably connected with the lens mount 2, that is, the support base 12 and the lens card are provided. The mouth 2 realizes relative rotation, that is, the lens assembly 1 and the lens mount 2 may be relatively rotated, and the lens mount 2 may be fixedly connected with the mounting body 4, and the lens assembly 1 may be relatively rotated with respect to the mounting body 4, thereby ensuring the lens assembly 1 The direction may always be rotated to the right direction to accommodate different models of mobile phones.

Specifically, the lens assembly 1 includes a lens of a plurality of optical components, which may be a wide-angle lens, a portrait lens or a movie lens, etc., and the lens mount 2 may be used to cooperate with the mounting body 4 on the smart device 5 to realize the lens structure and the smart device. The connection between 5, wherein the support base 12 and the lens mount 2 are rotated, compared to the relative rotation between the lens assembly 1 and the lens mount 2, the axial position of the lens assembly 1 need not be changed, only adjustment is required for the angle between the lens mount 2 and the support 12 ensures that the direction of deformation of the optical path is always in the correct direction.

Referring to FIG. 1 to FIG. 4 together, the lens structure according to embodiments of the present invention may now be described. In the lens structure, the lens mount 2 may be sleeved on the outer side of the support base 12, or the support base 12 may be sleeved on the outer side of the lens mount 2. Specifically, the relative rotation between the support base 12 and the lens mount 2 may be achieved. The rotation mode may be generally a nested manner, that is, the lens mount 2 may be nested inside the support base 12, that is, the lens mount 2 may be provided for The accommodating cavity 21 of the support base 12 may be accommodated, and the support base 12 may be rotated and fixed in the accommodating cavity 21, and the rotational connection between the lens mount 2 and the support base 12 may be realized in a nested manner. The support base 12 may also be nested inside the lens mount 2, that is, the support base 12 may be provided with a receiving cavity for receiving the lens mount 2, and the lens mount 2 may be rotated and fixed in the support base 12. Of course, according to the actual situation and the specific requirements, in other embodiments of the invention, the lens mount 2 may be provided with a guide rail for rotating and fixing the support base 12, which is not limited herein.

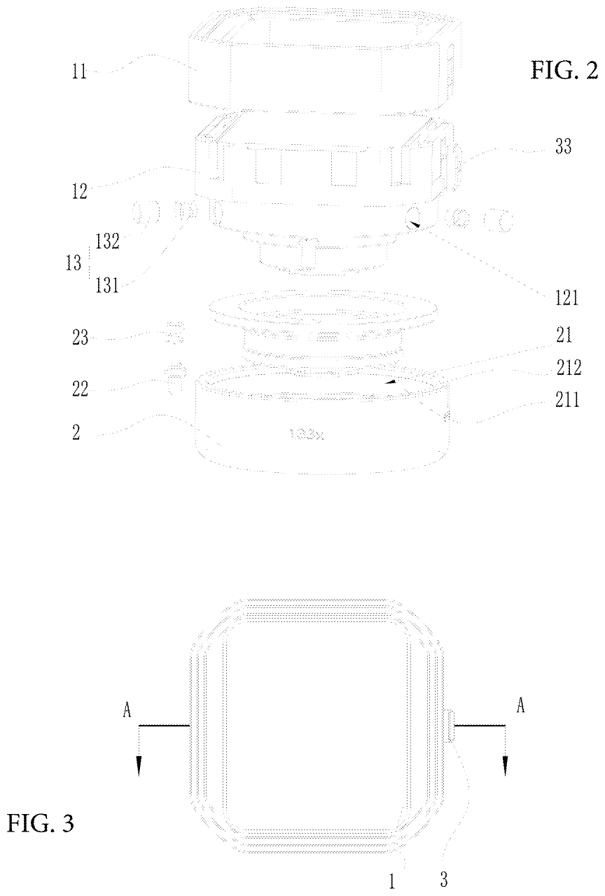

Further, please refer to FIG. 2 to FIG. 4, as a specific embodiment of the lens structure according to embodiments of the present invention, the support base 12 may be a hollow cylindrical ring seat, and the lens mount 2 includes a receiving body. The cavity 21 may be a hollow circular receiving cavity 21 and may be sleeved outside the bearing seat 12. Specifically, the cross-sectional shape of the support base 12 may be circular, the receiving cavity 21 may be also circular, and the receiving cavity 21 may be disposed on the outer side of the support base 12, so that the surrounding protection of the support base 12 may be realized and the support seat 12 may be realized. Fixed connection. The support base 12 may be a hollow cylindrical ring seat and may be disposed at the bottom of the mirror chamber 11, and a plurality of lenses are placed in the mirror chamber 11. Of course, according to the actual situation and specific needs, in other embodiments of the present invention, the support base 12 may be a hollow circular receiving cavity, the lens mount 2 may be embedded in the interior of the receiving cavity, and the support seat 12 and The cross section of the accommodating cavity 21 may also be a square with a rounded corner or other shape that may be rotated, which is not limited herein.

Further, please refer to FIG. 2 to FIG. 4. As a specific embodiment of the lens structure according to embodiments of the present invention, the support base 12 and the receiving cavity 21 are detachably connected by the elastic expansion and contraction assembly 13. Specifically, the support base 12 and the accommodating cavity 21 are detachably connected, and the elastic telescopic assembly 13 may be disposed on the outer side wall of the support base 12, and the gap between the support seat 12 and the inner side wall of the accommodating cavity 21 may be changed by the expansion and contraction of the elastic expansion and contraction assembly 13 to be elastic. After the expansion and contraction assembly 13 may be compressed, the support base 12 may be placed in the accommodating cavity 21, and the elastic expansion and contraction assembly 13 may be returned after being placed in the accommodating cavity 21, so that the fixing of the support base 12 and the accommodating cavity 21 may be realized, and the lens assembly may be conveniently realized. 1 and the assembly of the lens mount 2. The elastic expansion and contraction assembly 13 may be elastic, and may be assembled with the lens assembly 1 and the lens mount 2.

The support base 12 may be disposed inside the accommodating cavity 21 and the detachable connection of the support base 12 and the accommodating cavity 21 may be realized by the elastic expansion and contraction assembly 13, so that the support base 12 may rotate inside the accommodating cavity 21, and the support base 12 may be connected to the accommodating cavity 21 Disassembling, so that the lens assembly 1 and the lens mount 2 may be relatively rotated and disassembled, and the assembly of the lens assembly 1 and the lens mount 2 may be conveniently realized by using the elastic telescopic assembly 13. The lens mount 2 may be fixedly connected to the mounting body 4, and the lens assembly 1 may be relatively rotated with respect to the mounting body 4, thereby ensuring that the direction of the lens assembly 1 may always be rotated to the correct direction, thereby adapting to different types of mobile phones.

Further, referring to FIG. 2, as one embodiment of the lens structure according to embodiments of the present invention, the elastic telescopic assembly 13 includes a first elastic member 131 and at least one fixing leg 132 protruding from the support base 12. The two ends of the first elastic member 131 are respectively configured to abut against the support base 12 and the fixing leg 132. The inner side wall of the receiving cavity 21 may be provided with a guiding slot 211 for rotating the fixing leg 132. The fixing leg 132 may be embedded in the guiding groove 211. Specifically, one end of the first elastic member 131 may be configured to abut against the support base 12, and the other end may be configured to abut against the fixed leg 132. The fixing leg 132 may protrude from the side wall of the support base 12. The support leg 132 may be conveniently supported when being contracted. When the seat 12 and the accommodating chamber 21 are detached and the fixing legs 132 are extended, the fixing of the support base 12 and the accommodating chamber 21 may be achieved. The guide groove 211 may be a downwardly recessed guide groove 211 on the inner side wall of the accommodating cavity 21, and the fixing leg 132 may be moved in the guide groove 211, thereby realizing the rotation between the support seat 12 and the accommodating cavity 21, and the guide groove 211 The side wall may define the up and down movement of the fixing leg 132 to achieve the fixing of the fixing leg 132, thereby achieving the fixing between the bearing seat 12 and the lens mount 2. The fixing base 132 and the receiving cavity 21 are fixed by the fixing legs 132, and the assembly may be easily assembled by using the elastic contraction, and the fixing legs 132 may reduce the wear when the rotating legs 132 are engaged with the guiding groove 211 due to the small volume when rotating. Guarantee the service life of the entire lens structure.

Further, referring to FIG. 2, as a specific embodiment of the lens structure according to embodiments of the present invention, the outer side wall of the support base 12 may be provided with a recess 121, and the first elastic member 131 and the fixed leg 132 are respectively provided. In the groove 121, one end of the first elastic member 131 may be configured to abut against the inner wall of the groove 121, and the other end may be configured to abut against the fixing leg 132. Specifically, a recess 121 may be formed in the sidewall of the support base 12 for receiving the first elastic member 131 and the fixing leg 132. The first elastic member 131 generally adopts a resilient component such as a spring or a rubber cushion, and passes through the recess 121. The position of the first elastic member 131 may be limited to prevent the position of the first elastic member 131 from being displaced during use, and the fixing leg 132 may be telescoped in the recess 121 by the first elastic member 131. The groove 121 may also guide the movement of the fixing leg 132, so that the fixing leg 132 may always move back and forth toward the side of the receiving cavity 21, so that the fixing of the bearing seat 12 and the receiving cavity 21 may be better realized, and The frictional force of the rotation between the support base 12 and the accommodating chamber 21 may be increased to enhance the hand feeling during rotation.

Further, referring to FIG. 1 to FIG. 4, as a specific embodiment of the lens structure according to embodiments of the present invention, a rotation preventing assembly 3 for defining rotation of the lens assembly 1 and the lens mount 2 may be further included. Specifically, the rotation stop assembly 3 may be used to define the rotation between the lens assembly 1 and the lens mount 2, to prevent the lens assembly 1 from rotating or loosening after being rotated to the correct angle, thereby ensuring that the lens assembly 1 may be in use during use. Stability, which in turn ensures the use of the entire lens structure. The rotation preventing component 3 may be a snap structure, a latch structure or other detachable structure, and may also be a fixed structure such as a bolt, which is not limited herein.

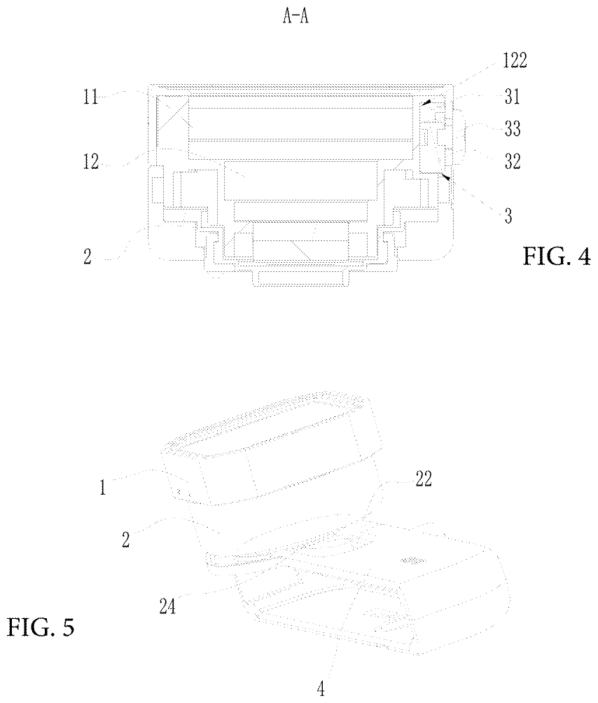

Further, referring to FIG. 2 and FIG. 4, as one embodiment of the lens structure according to embodiments of the present invention, the rotation preventing assembly 3 includes a second elastic member 31 and a second connection with the second elastic member 31. A retaining pin 32 may be formed on the support base 12 with a cavity 122 for receiving the second elastic member 31. One end of the first retaining pin 32 may be fixedly connected to the second elastic member 31, and the other end may be configured to abut the lens mount 2. Specifically, the second elastic member 31 is disposed inside the cavity 122, and one end of the second elastic member 31 may be configured to abut the inner sidewall of the cavity 122, and the other end of the second elastic member 31 may be coupled with the first pin. The first locking pin 32 is movable along the cavity 122 and may be configured to abut against the lens buckle, and the first locking pin 32 realizes a fixed connection of the lens mount 2 and the bearing seat 12. The second elastic member 31 generally adopts an elastic member such as a spring or an elastic rubber pad. Of course, the anti-rotation component 3 may also be a structure such as a buckle or a hook according to the actual situation and the specific requirements, which is not limited herein.

Further, referring to FIG. 2 and FIG. 5, as one embodiment of the lens structure according to embodiments of the present invention, the lens mount 2 is provided with at least one limiting hole 212 toward a side of the lens assembly 1. The first blocking pin 32 may be inserted into the limiting hole 212. Specifically, the limiting hole 212 is combined with the first blocking pin 32, and the first locking pin 32 may be inserted into the limiting hole 212, so that the first locking pin 32 may no longer follow the supporting seat. When the rotation of 12 is rotated, the limiting hole 212 may achieve a better limiting effect. The position of the limiting hole 212 may be generally set, and the limiting hole 212 may be uniformly and spacedly disposed on the lens. The outer edge of the bayonet 2; the number of the limiting holes 212 may be plural, and the unevenly disposed holes 212 are in a specific position, and the first blocking pin 32 is inserted into the limiting hole 212, the lens The structure may be applied to one or more types of smart devices 5.

Further, referring to FIG. 2, as one embodiment of the lens structure according to embodiments of the present invention, the number of the limiting holes 212 is at least two, and the two of the limiting holes 212 are buckled in the lens. The upper angle is 90 degrees. Specifically, in the prior art, the manner in which the buckle is implemented by using the connecting buckle is required to be rotated by 90 degrees, and the rotation tightening directions required by different types of mobile phones are inconsistent, so the angle of the lens should be different by 90 degrees. Two limiting holes 212 may be disposed when the limiting hole 212 is disposed, and the two limiting holes 212 are located on the lens mount 2, and the angles of the two limiting holes 212 are 90 degrees apart, and the buckle may be adapted at this time. Need to rotate 90 degrees of locking, and the problem of inconsistent tightening directions. Certainly, other limit holes 212 corresponding to different types of mobile phones may be disposed in other embodiments of the present invention according to actual conditions and specific requirements, which are not limited herein.

Further, referring to FIG. 2 and FIG. 4, as one embodiment of the lens structure according to embodiments of the present invention, the rotation preventing assembly 3 further includes a dial 33 for driving the first blocking pin 32 to move up and down. Specifically, the dial 33 may be fixedly connected to the first stop pin 32, and the first stop pin 32 may be moved up and down by the dial key 33, thereby controlling the relative relationship between the lens assembly 1 and the lens mount 2 through the dial key 33. Turn. When the lens assembly 1 is rotated to the correct position, the second elastic member 31 is compressed. When moving to the limiting hole 212, the first blocking pin 32 may fall into the limiting hole 212 due to the returning force of the second elastic member 31. Therefore, the movement of the first blocking pin 32 is restricted by the limiting hole 212, thereby restricting the rotation of the lens assembly 1 to realize automatic locking; when the lens assembly 1 is required to be rotated, the first blocking pin 32 is raised and left by the dial 33. The bit hole 212 may achieve continuous rotation of the lens assembly 1.

Preferably, the dial key 33 is engaged with the first stop pin 32, and the lens mount 2 is provided with a through hole through which the dial key 33 passes. Specifically, the dial key 33 and the first stop pin 32 are snap-connected, and the dial key 33 is disposed on the outer side of the lens mount 2, and the shape of the through hole is generally elongated or waist-shaped, so that the upper and lower sides of the dial 33 may be conveniently Move, it's easier to control.

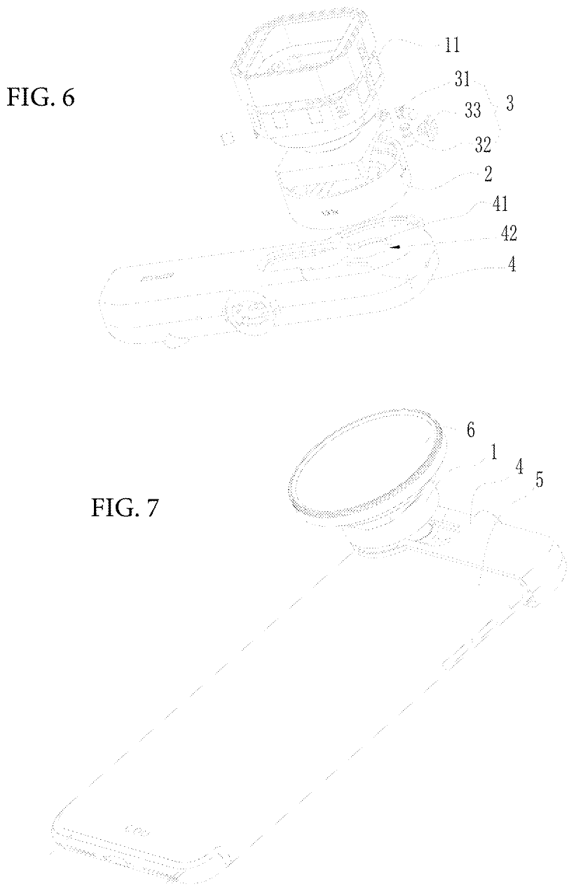

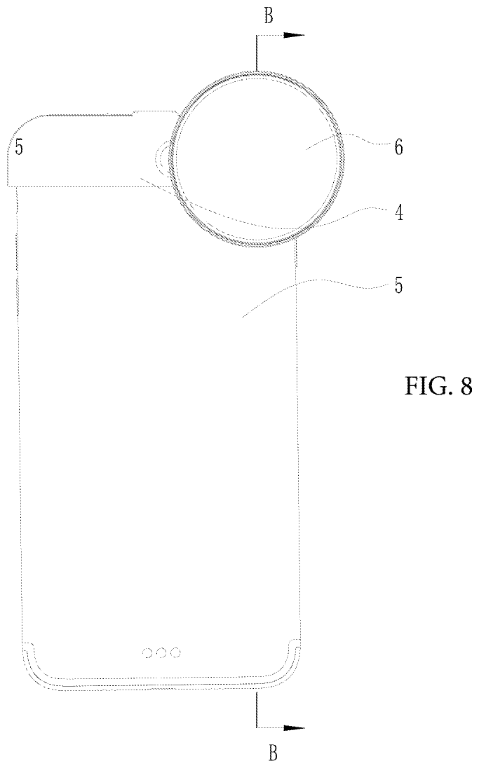

Referring to FIG. 5 to FIG. 9, the present invention further provides an additional lens mechanism including the lens structure and the mounting body 4 for cooperating with the smart device 5 as described in any of the above embodiments. The lens structure is mounted on the smart device 5 through the mounting body 4.

The additional lens mechanism according to embodiments of the present invention divides the lens assembly 1 and the lens mount 2 into two separate components. The support base 12 is disposed inside the accommodating cavity 21 and may be realized by the elastic telescopic assembly 13 for the support base 12 and the accommodating cavity 21. The connection is disassembled so that the support base 12 may rotate inside the accommodating cavity 21, and the support base 12 may be detachable from the accommodating cavity 21, so that the lens assembly 1 and the lens mount 2 may be relatively rotated and disassembled, and the elastic telescopic assembly 13 may be used. The assembly of the lens assembly 1 and the lens mount 2 is conveniently implemented. The lens mount 2 may be fixedly connected to the mounting body 4, and the lens assembly 1 may be relatively rotated with respect to the mounting body 4, thereby ensuring that the direction of the lens assembly 1 may always be rotated to the correct direction, thereby adapting to different types of mobile phones.

Specifically, the mounting body 4 is generally directly sleeved on the smart device 5, and the mounting body 4 and the lens structure are engaged, bonded or integrally formed, so that the lens structure and the smart device 5 are fixedly connected, and the mounting body 4 may be a smart device. The housing of the 5 may also be a fixing sleeve that is attached or sleeved on the smart device 5.

Further, referring to FIG. 5 to FIG. 9, as a specific implementation manner of the additional lens mechanism according to embodiments of the present invention, the lens mount 2 is detachably mounted on the mounting body 4. Specifically, the mounting body 4 and the lens mount 2 may be disassembled for convenient disassembly and assembly, and the assembly is more convenient. The mounting main body 4 is provided with an annular card slot 41, and the annular card slot 41 is provided with a notch 411; the lens mount 2 The outer periphery of the bottom portion is provided with an engaging protrusion 24, and the engaging protrusion 24 may enter the inside of the annular card slot 41 via the notch 411, and rotate inside the annular card slot 41, so that the engaging protrusion 24 may be combined with the annular card slot 41. The inner walls may be configured to abut, thereby achieving a snap fit. Of course, the lens mount 2 may be mounted to the mounting body 4 by other detachable means according to the actual situation and specific requirements, which is not limited herein.

Further, referring to FIG. 5, as a specific implementation manner of the additional lens mechanism according to embodiments of the present invention, the bottom of the lens mount 2 is provided with a second stop pin 22 defining an angle of the lens structure and the mounting body 4. Specifically, the second stopper pin 22 is disposed at the bottom of the lens mount 2 for defining the relative rotation between the lens structure and the mounting body 4, and the second stopper pin 22 is generally a convex portion protruding from the lens mount 2 The protruding portion may be configured to abut against the side wall of the mounting body 4, or a groove or a stopper disposed on the mounting portion of the main body 4 to define the position of the lens structure, and further to the lens structure and the mounting body 4 The angle between them is limited.

Further, referring to FIG. 2 and FIG. 5, as a specific implementation manner of the additional lens mechanism according to embodiments of the present invention, the second locking pin 22 and the lens mount 2 are connected by a third elastic member 23, and the second stopper pin 22 may be configured to abut against the mounting body 4. Specifically, the third elastic member 23 may drive the elastic displacement of the second retaining pin 22, and the bottom of the lens mount 2 is provided with a through hole for receiving the third elastic member 23 and the second retaining pin 22, and the second retaining pin 22 may The up and down displacement is realized in the through hole, and the third elastic member 23 is used to facilitate the disassembly of the lens mount 2.

Further, referring to FIG. 7 to FIG. 9, as a specific implementation manner of the additional lens mechanism according to embodiments of the present invention, a filter 6 is further included, and the filter 6 is detachably fixed to the mirror chamber 11 away from the lens. One side of the bayonet 2. Specifically, the lens mechanism is generally provided with a filter 6 through which the lens mechanism may be improved. The filter 6 is generally directly fixed to the lens assembly 1, and the filter 6 and the lens assembly are respectively 1 detachable connection. The type of the filter 6 is generally CPL (circular polarizer) or adjustable ND (medium gray density mirror), etc., the filter 6 may need to be rotated during use, and the lens assembly 1 may be ensured by the anti-rotation component 3 It may rotate with the rotation of the filter 6, ensuring that the lens assembly 1 may always be at the correct angle.

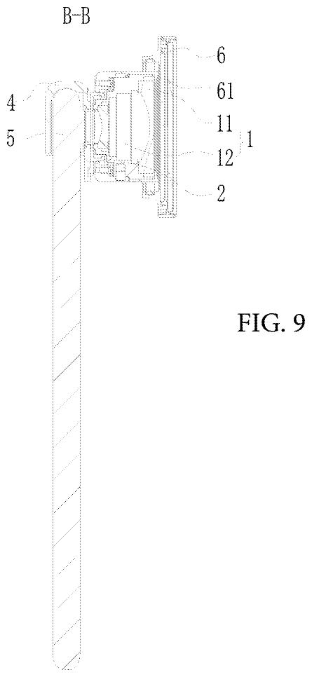

Further, referring to FIG. 9, as a specific implementation manner of the additional lens mechanism according to embodiments of the present invention, a rubber strip 61 is disposed between the filter 6 and the mirror chamber 11. Specifically, the generally concave cavity 122 in the filter 6 is sleeved on the mirror chamber 11. The rubber strip 61 is disposed inside the cavity 122 and outside the mirror chamber 11, and is obtained by interference fit of the rubber strip 61. Appropriate insertion and removal forces make the connection of the mirror chamber 11 and the filter 6 more convenient, making the entire filter 6 smaller in size.

It is apparent that the above-described embodiments are merely illustrative of the examples, and are not intended to limit the embodiments. Other variations or modifications of the various forms may be made by those skilled in the art in light of the above description. There is no need and no way to exhaust all of the implementations. Obvious changes or variations resulting therefrom are still within the scope of the invention.

1: A lens structure comprising:
a lens assembly (1); and
a lens mount (2), the lens assembly (1) comprising a mirror chamber (11) and a support seat provided at a bottom of the mirror chamber (11) (12) The lens mount (2) is rotatably coupled to the support base (12).

2: The lens structure of claim 1, wherein the lens mount (2) is sleeved on an outer side of the support base (12), or the support base (12) is sleeved on the outer side of the lens mount (2).

3: The lens structure of claim 2, wherein the support base (12) is a hollow cylindrical ring seat, wherein the lens mount (2) includes a receiving cavity (21), and the receiving cavity (21) is a hollow circular receiving cavity (21) and nested outside of the support seat (12).

4: The lens structure of claim 3, wherein the support seat (12) and the receiving cavity (21) are detachably connected by an elastic expansion and contraction assembly (13).

5: The lens structure of claim 4, wherein the elastic telescopic assembly (13) includes a first elastic member (131) and at least one fixing leg (132) protruding from the support base (12), and the two ends of the first elastic member (131) respectively connect the support base (12) and the fixing leg (132), and the inner side wall of the receiving cavity (21) is provided with a guiding groove (211) for rotating the fixing leg (132), wherein the fixing leg (132) is configured to embed in the guide groove (211).

6: The lens structure of claim 5, wherein the support seat (12) comprises an outer side wall, wherein the outer side wall of the support seat (12) is provided with a groove (121), and the first elastic member (131) and the fixing leg (132) are both disposed in the groove (121), and one end of the first elastic member (131) is configured to abut against the inner wall of the groove (121), and the other end is configured to abut against the fixing leg (132).

7: The lens structure of claim 1, further comprising a rotation limiting assembly (3) for defining a rotation of the lens assembly (1) and the lens mount (2).

8: The lens structure of claim 7, wherein the rotation limiting assembly (3) comprises a second elastic member (31) and a first stopper pin (32) connected to the second elastic member (31), and the support seat (12) is formed with a housing a cavity (122) of the second elastic member (31), one end of the first blocking pin (32) is fixedly connected to the second elastic member (31), and the other end is connected to the lens mount (2).

9: The lens structure of claim 8, wherein the lens mount (2) is provided with at least one limiting hole (212) toward a side of the lens assembly (1), the first locking pin (32) is configured to insert into the limiting hole (212).

10: The lens structure of claim 9, wherein the number of the limiting holes (212) is at least two, and the angle between the two limiting holes (212) on the lens clip is 90 degrees.

11: The lens structure of 8, wherein the rotation limiting assembly (3) further comprises a dial key (33) for driving the first blocking pin (32) to move up and down.

12: An external lens structure of claim 1, wherein the lens structure and a mounting body (4) are configured to match with a smart device (5), the lens structure is configured to mount to the smart device (5) by the mounting body (4).

13: The external lens structure of claim 12, wherein the lens mount (2) is detachably mounted on the mounting body (4).

14: The external lens structure of claim 12, wherein the bottom of the lens mount (2) is provided with a second stop pin (22) defining an angle of the lens structure and the mounting body (4).

15: The external lens structure of claim 14, wherein the second stopper pin (22) is connected to the lens mount (2) through a third elastic member (23), and the second stopper pin (22) is opposite to the side wall of the mounting body (4).

16: The external lens structure of claim 12, further comprising a filter (6) detachably fixed to a side of the mirror chamber (11) away from the lens mount (2).

17: The external lens structure of claim 16, further comprising a soft strip (61) disposed between the filter (6) and the mirror chamber (11).
